(19) United States
(12) Patent Application Publication
(10) Pub. No.: US 2006/0158326 A1
(43) Pub. Date: Jul. 20, 2006

(54) System and method for fusion of container tracking data

(76) Inventor: Linda G. Easley, Mc Lean, VA (US)

Correspondence Address: Baker & Daniels, Ste. 700, 805 15th Street, N.W., Washington, DC, 20005, US

(21) Appl. No.: 11/296,421

(22) Filed: Dec. 8, 2005

Related U.S. Application Data
(60) Provisional application No. 60/634,543, filed on Dec. 10, 2004.

(51) Int. Cl. G08B 19/00; G08B 1/08; G08B 5/22

(52) U.S. Cl. 340/522; 340/539.13; 340/539.22; 340/825.49

(57) ABSTRACT

The present invention is directed to a method and system for data fusion. The method and system gather and analyze data from container tracking sources to produce intelligent output. The container tracking sources include at least one container sensing system for monitoring contents of a container. The data fusion system may include a data intake component for accepting container tracking data from multiple container tracking sources and a data authentication component for authenticating the container tracking data and creating container information. The data fusion system may additionally include data analysis components for analyzing the information to create container intelligence and communication tools for providing real-time communications to convey container intelligence. The system may additionally include mapping components for generating intelligence reports and providing a user interface for facilitating viewing of the intelligence reports in geographical context.

### PRIORITY DATA

The present application claims priority to U.S. Provisional Patent Application Ser. No. 60/634,543 filed on Dec. 10, 2004.

### TECHNICAL FIELD

Embodiments of the present invention relate to container security. More particularly, embodiments of the invention are directed to gathering data from data sources including container security systems and fusing the data to create useful information and intelligence.

### BACKGROUND OF THE INVENTION

Currently, in the field of transportation security, there is a need to cost-effectively and accurately monitor the contents of containerized shipments. This need exists both in the United States and abroad. U.S. patent application Ser. No. 10/934,676, filed on Sep. 3, 2004, and hereby incorporated by reference, addresses this need by providing a System and Method for Providing Container Security.

The above-identified patent application provides an automated system for monitoring containers during shipment. The monitoring system provided is able to generate monitoring data pertaining to monitored containers during shipment. The system also includes a processing system for processing the generated monitoring data and a communication system for communicating alerts pertaining to the monitored containers. Prior to the solution identified in the referenced patent application, no solution had adequately addressed the needs of the transportation industry and government agencies charged with monitoring shipments.

Shipping containers are used to transport much of the commerce entering, leaving and moving within the United States. Shipping containers have revolutionized transportation by reducing the number of times goods must be loaded and unloaded during transport. However, the contents of shipping containers can be difficult to monitor and track. It is impractical to stop and check contents of containers individually at each point of transit. Most existing monitoring systems include computer tracking systems that monitor the locations of individual containers from origin to destination and maintain an inventory of loaded and empty containers. These systems commonly rely on transponders mounted on the containers that send messages to satellites or ground stations, from which messages are re-routed to shipping companies, freight forwarders, and other entities. However, these tracking systems are unable to guarantee that a given container does not contain contraband. A system has been developed for inspecting container contents, but this system is costly and slows the transport of containers.

The referenced patent application provides a system that enables shipping containers to be self-evaluating and self-reporting as to cargo status. The system includes multiple types of sensors that are managed by a sensor management system. The sensors may include a motion sensor, a micro-bolometer for detecting the presence of people and animals, a smoke detector, a light sensor, a vibration sensor, a temperature sensor, an auditory sensor, and/or a container integrity sensor. Additional sensors may also be included.

Although the above-referenced patent application suggests a need for a centralized tool for collecting and analyzing data including a processing system, it does not disclose the particular structure of such a centralized system.

Accordingly, a need exists for a centralized system to consolidate signals, alarms and reports generated by the monitoring systems. A centralized solution is further needed for assisting agents and shippers in making decisions regarding the safety and status of each container. Furthermore a solution is needed that assists agencies and shippers in identification and removal of unsafe and suspicious containers from commerce.

### BRIEF SUMMARY OF THE INVENTION

In one aspect, a data fusion system is provided for gathering and analyzing data from container tracking sources to produce intelligent output, wherein the container tracking sources include at least one container sensing system for monitoring contents of a container. The data fusion system may include a data intake component for accepting container tracking data from multiple container tracking sources and a data authentication component for authenticating the container tracking data and creating container information. The data fusion system may additionally include data analysis components for analyzing the information to create container intelligence and communication tools for providing real-time communications to convey container intelligence.

In an additional aspect, a method is provided for gathering and analyzing data from container tracking sources to produce intelligent output, wherein the container tracking sources include at least one container sensing system for monitoring contents of a container. The method may include accepting container tracking data from multiple container tracking sources using a data intake component and authenticating received container tracking data to create container information using an authentication component. The method may additionally include analyzing the information to create container intelligence and providing real-time communications to convey container intelligence.

In yet a further aspect of the invention, a data fusion system may be provided for gathering and analyzing data from container tracking sources to produce intelligent output, wherein the container tracking sources include at least one container sensing system for monitoring contents of a container. The data fusion system may include a data intake component for accepting container tracking data from multiple container tracking sources and a data authentication component for authenticating the container tracking data and creating container information. The data fusion system may additionally include data analysis components for analyzing the information to create container intelligence and mapping components for generating intelligence reports and providing a user interface for facilitating viewing of the intelligence reports in geographical context.

### BRIEF DESCRIPTION OF THE DRAWINGS

The present invention is described in detail below with reference to the attached drawings figures, wherein:

FIG. 1 is a block diagram illustrating components of a data fusion center environment in accordance with an embodiment of the invention;

FIG. 2 is a block diagram illustrating components of a data fusion center computing environment in accordance with an embodiment of the invention;

FIG. 3 is a block diagram illustrating components of a data fusion system in accordance with an embodiment of the invention;

FIG. 4 is a flow chart illustrating a data fusion process in accordance with an embodiment of the invention;

FIG. 5 is a screen display illustrating user interface tools provided by a mapping system in accordance with an embodiment of the invention;

FIG. 6 is a screen display illustrating an additional mapping user interface in accordance with an embodiment of the invention;

FIG. 7 is a screen display illustrating yet an additional mapping user interface in accordance with an embodiment of the invention;

FIG. 8 is a screen display illustrating a report produced by the mapping system in accordance with an embodiment of the invention;

FIG. 9 is a screen display illustrating a chat user interface produced by the mapping system in accordance with an embodiment of the invention; and

FIG. 10 is an additional screen display illustrating types of reports generated by the mapping system.

### DETAILED DESCRIPTION OF PREFERRED EMBODIMENTS

Embodiments of the present invention are directed to a system and method for data fusion. Data pertaining to containers can come from many sources and in a variety of formats. The data fusion center integrates and analyzes the data within the context of the supply chain to create information. The data fusion center also compares the information against known time standards and expected operational profiles to gain knowledge or intelligence about a container's security condition.

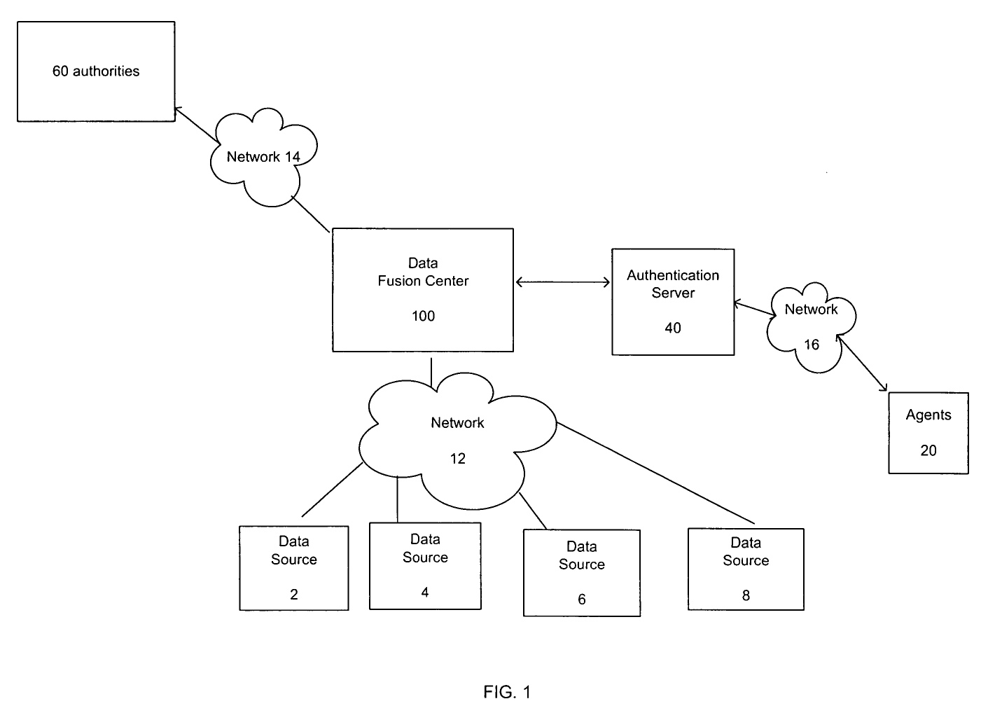

FIG. 1 is a block diagram illustrating components of a data fusion center environment in accordance with an embodiment of the invention. Data sources 2, 4, 6, and 8 are associated with containers and deliver data over a network 12 to a data fusion center 100. Although the network 12 is illustrated as a single network, it may actually include multiple different types of networks. The data fusion center 100 processes the data from the sources 2, 4, 6, and 8 so that the data may contribute to tracking intelligence reports. Agents 20 may access the data fusion center 100 by communicating over a network 16 with an authentication server 40 that is connected with the data fusion center 100. The data fusion center 100 may communicate over a network 14 to generate alerts or otherwise communicate with authorities 60. As with network 12, the networks 14 and 16 may include multiple different types of networks.

The data sources 2, 4, 6, and 8 may include fixed readers and portals, moving readers and GPS wireless solutions, dynamic tracking devices, and other sources. The fixed readers and portals may be static devices that periodically send data to the data fusion center 100. The moving readers and GPS wireless solutions may include agent based solutions that are controlled and monitored by agents. The dynamic tracking devices and alarms may include carrier tracking devices that track movement of trucks, ships, trains, barges, etc. The dynamic tracking devices may additionally include container tracking sensors such as those described above with reference to U.S. patent application Ser. No. 10/934,676. The dynamic tracking devices may further include cargo monitors that monitor containers including contents such as hazardous materials and dry ice refrigeration. The alarms may include container seal interrogation mechanisms for ensuring container integrity.

The authentication server 40 provides technology capable of verifying agent identity. When agents 20 attempt to access the data fusion center 100, in embodiments of the invention, the agent 20 calls the server 40 and the server 40 utilizes voice recognition to verify agent identity. The server 40, upon authenticating agent identity, may provide the agent with a personal identification number that the agent can use to access the data fusion center 100. When accessing the data fusion center 100, the agent may be required to enter a user ID and a password in addition to the personal identification number provided by the server 40.

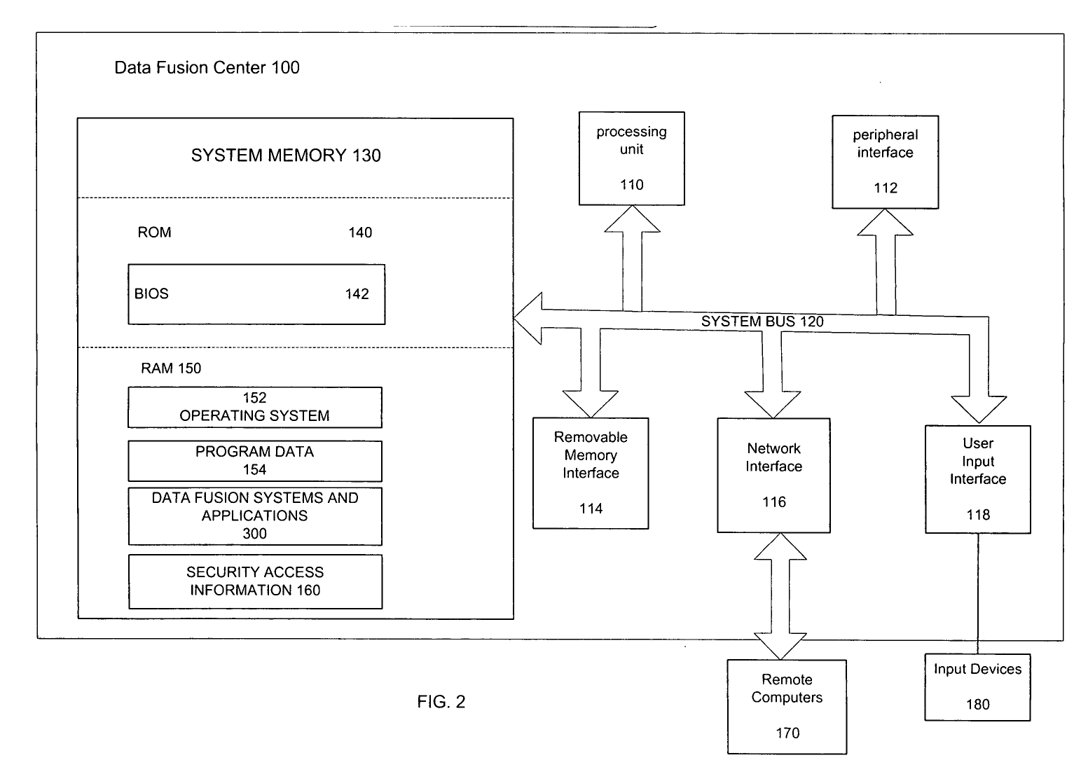

FIG. 2 illustrates details of a simplified data fusion center 100 in accordance with an embodiment of the invention. The data fusion center 100 is illustrated as incorporating a single computer system in the displayed preferred embodiment. However, in additional preferred embodiments, the data fusion center 100 will be distributed over multiple computing devices. Those computing devices will have components similar to those displayed in FIG. 2.

In the illustrated system, the data fusion center 100 may include a processing unit 110, a peripheral interface 112, a removable memory interface 114, a network interface 116, and a user input interface 118. The data fusion center 100 may also include a memory 130. A system bus 120 may be used to couple the aforementioned components.

The system memory 130 may include computer storage media in the form of volatile and/or nonvolatile memory such as read only memory (ROM) 140 and random access memory (RAM) 150. A basic input/output system (BIOS) 142, containing the basic routines that help to transfer information between elements within the data fusion center 100, such as during start-up, is typically stored in ROM 140. RAM 150 typically contains data and/or program modules that are immediately accessible to and/or presently being operated on by processing unit 110.

The RAM 150 may include an operating system 152, program data 154, security access information 160, and data fusion system applications 300. The data fusion system and applications 300 and any other application programs stored in RAM 150 may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The data fusion center 100 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus 120 through a non-removable memory interface. The magnetic disk drive and optical disk drive are typically connected to the system bus by a removable memory interface.

A user may enter commands and information through the user input interface 118 using input devices such as a keyboard and pointing device, commonly referred to as a mouse, trackball or touch pad. Other input devices may include a microphone, satellite dish, scanner, or the like. These and other input devices are often connected to the processing unit 110 through the user input interface 118 that is coupled to the system bus 220, but may be connected by other interface and bus structures, such as a parallel port or a universal serial bus (USB). A monitor or other type of display device and other peripherals may also be connected to the system bus 120 via an interface, such as the peripheral interface 112.

The illustrated data fusion center 100 is merely an example of a suitable environment for the system of the invention and is not intended to suggest any limitation as to the scope of use or functionality of the invention. Neither should the data fusion center 100 be interpreted as having any dependency or requirement relating to any one or combination of components illustrated.

The data fusion center 100 in the present invention may operate in a networked environment using logical connections to communicate with networked components. Logical connections for networking may include a local area network (LAN) or a wide area network (WAN), but may also include other networks. When used in a LAN networking environment, the system may be connected to the LAN through the network interface 116 or adapter. When used in a WAN networking environment, the data fusion center 100 typically includes a modem or other means for establishing communications, such as the Internet. The modem, which may be internal or external, may be connected to the system bus 120 via the user input interface 118 or other appropriate mechanism.

Although only the data fusion center 100 has been described in detail with respect to the appropriate computerized environment, it should be understood that the other components shown in FIG. 1 operate in a similar computerized environment.

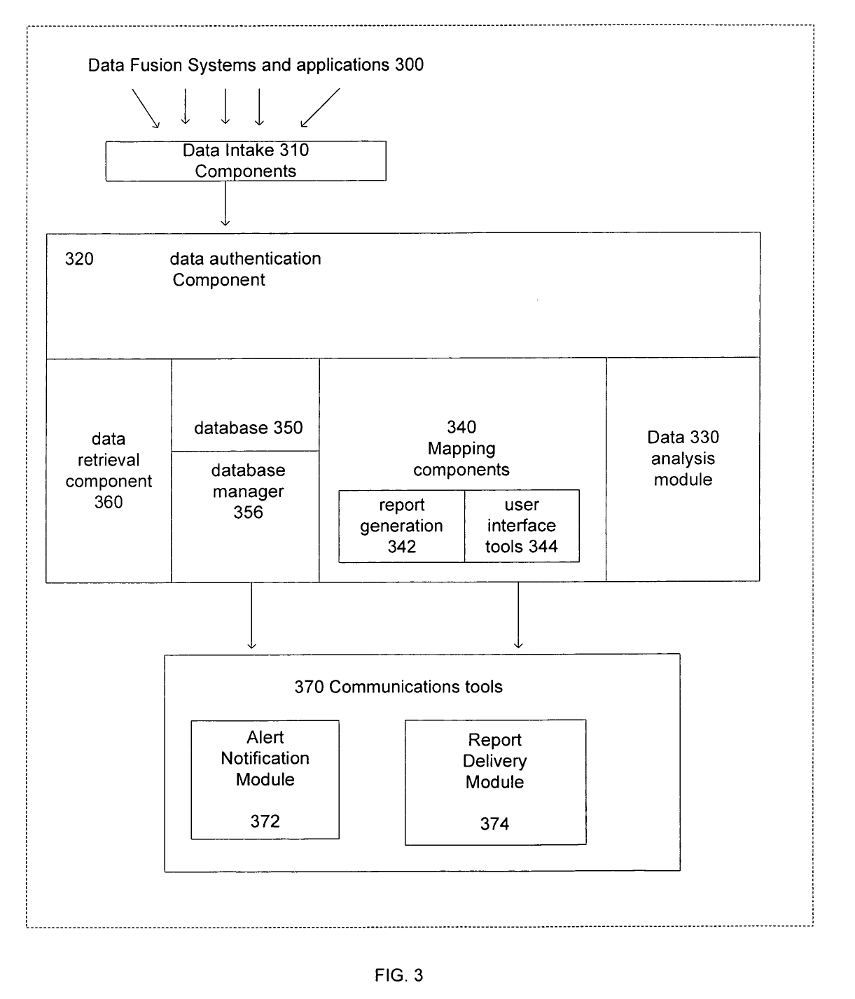

FIG. 3 is a block diagram illustrating the data fusion systems and applications 300 in accordance with an embodiment of the invention. The data fusion applications 300 may include data intake components 310 for receiving container data from the sources described above. Data authentication components 320 may authenticate the data accepted from the data sources. A data analysis module 330 may provide tools for analyzing the authenticated data. Mapping components 340 may include a report generation module 342 and user interface tools 344 for viewing generated reports in geographic context. The system 300 may also include a database 350 and database manager 356. A data retrieval component 360 may operate to retrieve data for authorized agents and communicate the retrieved data through communications tools 370. The communication tools 370 may include an alert notification module 372 for notifying authorities of container status and conditions. The communications tools 370 may also include a report delivery module 374 for delivering requested reports to authorized agents.

The data intake components 310 are capable of parsing information received in various communication formats. The data intake components 310 may receive data in formats including encrypted data format, SMS messages, e-mail, Electronic Data Information (EDI), EDI-FAX, XML, X.12, and other formats. The data intake components 310 may interpret sensor data and interpret security reports from the agents 20. The agents 20 may forward information to the data intake components 310 through pre-formatted emails or facsimiles. The agents 20 may also provide tracking data to operators of the data fusion center 100 using text messages. The operators would then use input devices to enter the data in the data fusion center 100.

The data intake components 310 may receive tracking information from data sources 2, 4, 6, and 8 as satellite derived tracking information from systems such as Globalstar or INMARSAT. Preferably, the data intake components 310 will receive information from sensor suites as described in co-pending patent application Ser. No. 10/934,676. The data intake components 310 may include a decryption routine for converting the satellite information into latitude and longitude information.

The data authentication components 230 operate to ensure security of incoming data and the actionable intelligence generated by the data fusion center 100. Data authentication components 230 operate in addition to and/or in conjunction with the data authentication server 40. The data authentication components 230 may provide an extra layer or multiple extra layers of security. Once authenticated, data processed by the data authentication components 230 becomes authenticated information.

The data analysis module 330 correlates received tracking information and logistics information received from the data sources 2, 4, 6, and 8 with human intelligence reports from the agents 20 and stores the intelligence in the database 350. Through the analysis, the data fusion center 100 achieves a consolidated understanding of the current security condition of each container in the system. Algorithms implemented by the data analysis module 330 are capable of multi-sensor data fusion for combining data from multiple and diverse sensors and other sources in order make inferences about events, activities, and situations. In one preferred embodiment of the invention, the data analysis module 330 implements a Kalman filter. A Kalman filter is an optimal recursive data processing algorithm capable of estimating the state of a process in a manner that minimizes the mean of the squared error. The filter supports estimations of past, present, and future states even when the precise nature of a modeled system is unknown. The Kalman filter incorporates all information it receives and processes all available measurements to estimate the current status of a target. The operation of the Kalman filter over time produces more accurate results.

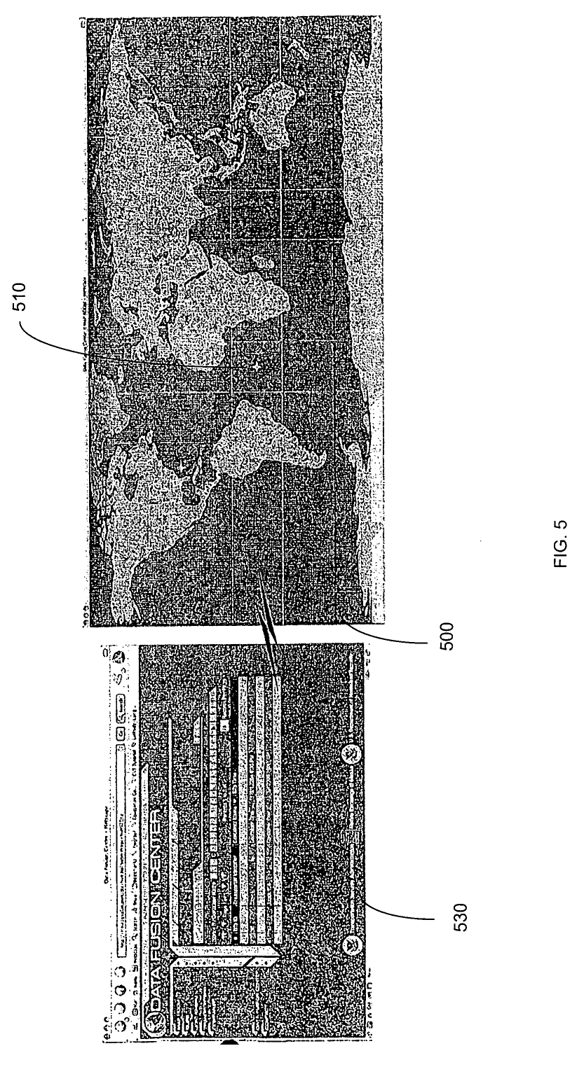

The mapping components 340, though shown as consolidated with other data fusion center components, may be located on a separate server. The mapping components 340 include geographic information systems software and may permit a data fusion center operator to view information, the sources of the information, and where the sources are located. The functionality of the mapping components is further illustrated below with respect to FIGS. 5-9. The mapping components 340 may include report generation tools 342 that produce reports pertaining to tracked items and user interface tools 344 that facilitate viewing of these reports.

Data and information may be stored in the database 350 or other storage area. Additional storage areas may be provided on-site and off-site from the data fusion center 100. The database manager 356 manages stored data including data in different formats. The database manager 356 will further provide indexing, query processing, and optimization of data.

The data retrieval component 360 may utilize information retrieval algorithms that ensure parsing of all information available in the data fusion center 100. The data fusion center 100 will access files through the data retrieval components 360 using generalized read and write commands. Use of these commands allows information associated with a file other than its data bytes to be read and written, for example, its size or protection information associated with the file. In operation, if a client requests information, the data retrieval component 360 may execute a search command by sending a message containing the command to an appropriate data storage area. When the command has been completed, a response is forwarded. The data retrieval component 360 may implement a data mining process for retrieving information.

The communication tools 370 may operate to control communication from the data fusion center. The alert notification module 372 generates alerts for authorities based on analyzed data. The report delivery module 374 is capable of generating reports for authorized requesting agents or for data fusion center operators.

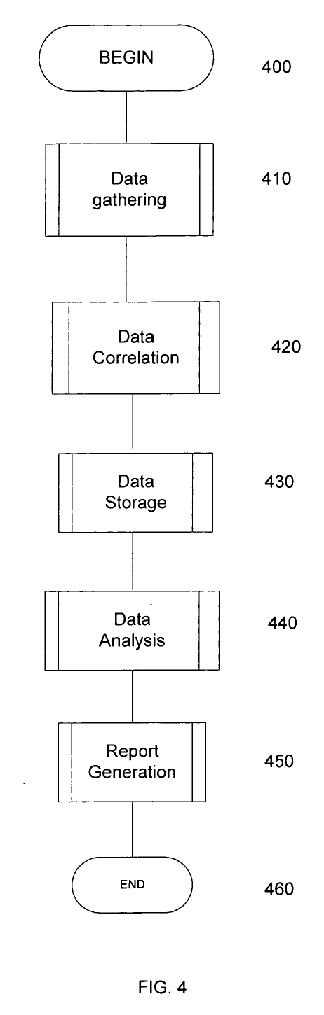

FIG. 4 is a flow chart illustrating a main process flow for handling information directed to the data fusion center 100. The process begins in step 400 and the data fusion center performs data gathering at 410. The data gathering procedure includes intake of data from various sources as explained above and may also include data authentication. In step 420, the data fusion center performs data correlation and in step 430, the data fusion centers stores the data. Data analysis and report generation occur in steps 440 and 450 respectively. These steps and the order of these steps are merely exemplary. Once gathered, the incoming data may be processed using any number of techniques as long as these techniques produce useful intelligence as an outcome.

FIG. 5 is a screen display illustrating a user interface screen 500 that may be presented by the user interface tools 344 of the mapping components 340. The user interface tools 344 may be available to a browser of a user connecting to the data fusion center 100. The opening screen 500 may include an interactive map including a blip 510 illustrating a container location. By clicking on a blip, the user may access data fusion center information screen 530. The data center information screen 530 enables the user to drill down reports on blip attributes.

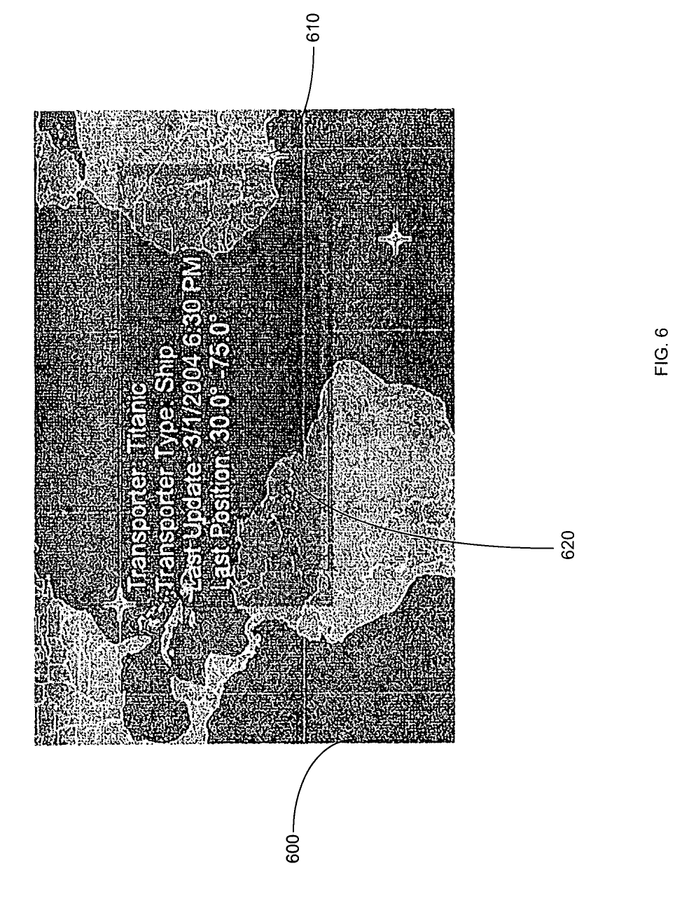

FIG. 6 illustrates a user interface 600. When a user selects a blip 610, the system will display some initial attributes. In the displayed example, the attributes include a blip identifier or transporter name, a blip or transporter type, a last location, and the time last updated.

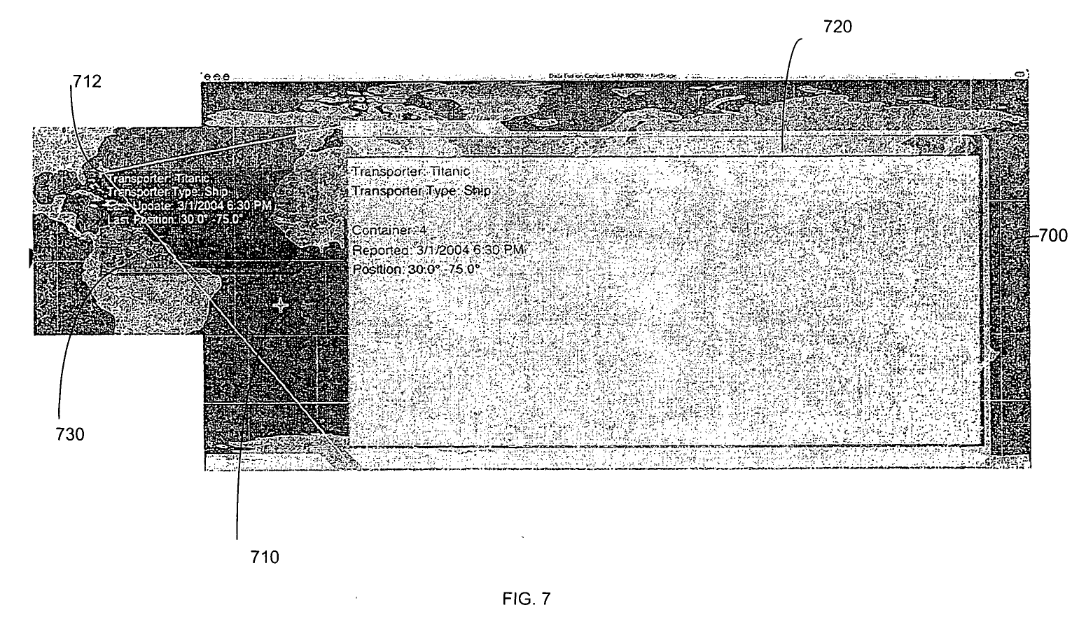

FIG. 7 illustrates a screen display 700 that includes blips 710 and 712. Blip 712 has been selected to display a report 730. A report selection screen 720 may be activated to allow a user to drill down to a transporter or specific container.

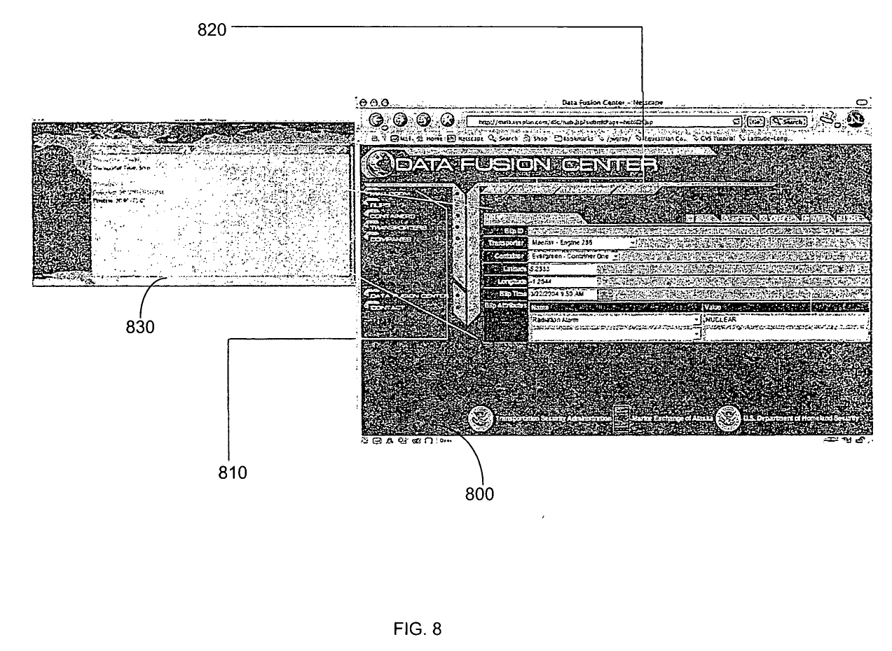

FIG. 8 illustrates a user screen 830 from which a user can click on a report link and be taken to the data fusion center command console screen 800. The screen 800 allows users to drill deeper by accessing reports pertaining to blips, containers, transporters, and companies as illustrated by menus 810 and 820.

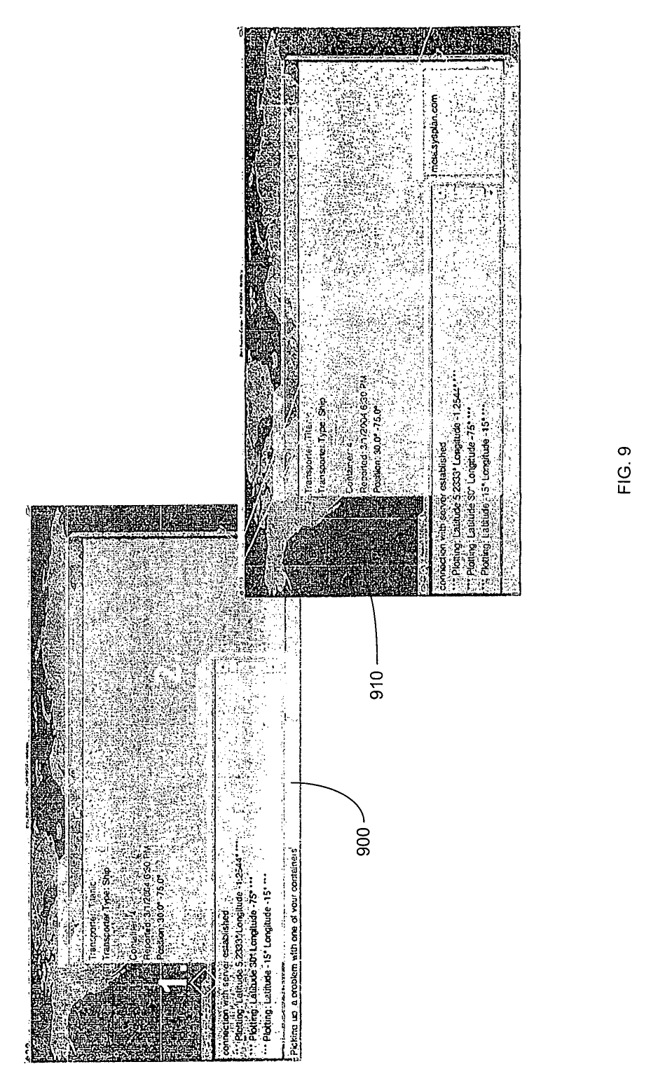

FIG. 9 is a screen display illustrating a chat feature that may be offered. In a screen 900, a user may click on an expand icon at position “1” on the lower left of the map portion of the screen. A chat screen 910 will appear and the user is able to view a list of current users available for chatting in a lower right portion of the screen.

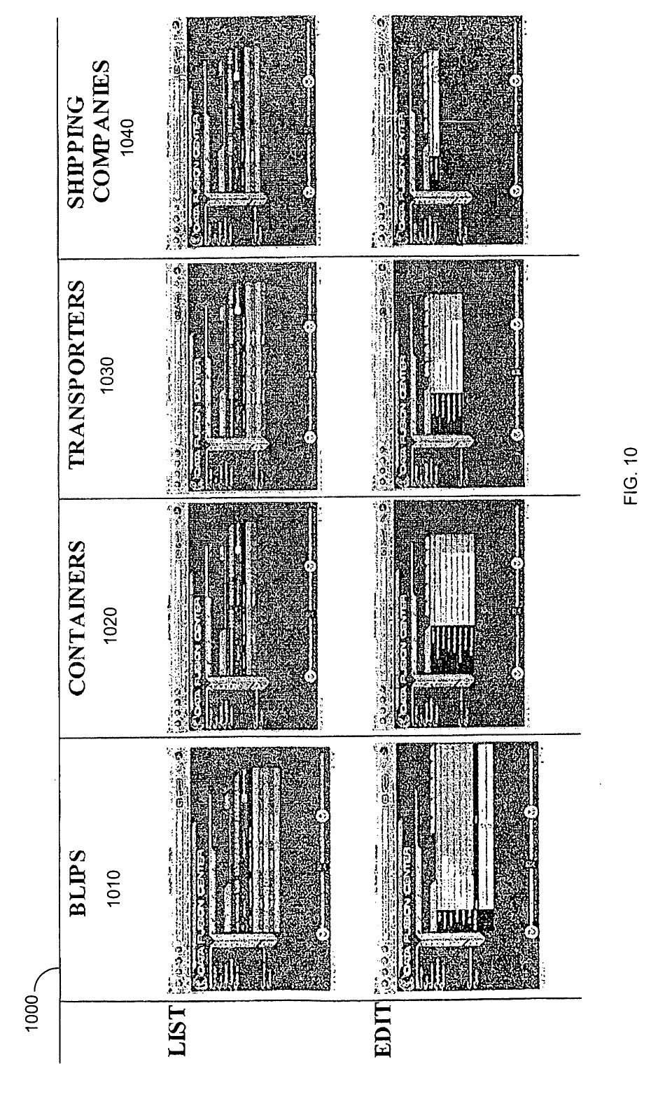

FIG. 10 is a reports overview 1000 illustrating the variety of reports that may be made available. The reports may include blip reports 1010, container reports 1020, transporter reports 1030, and shipping company reports 1040. Users having predetermined rights may switch from a list mode to an edit mode in order to alter report information. The interface preferably allows sorting options and auto fill options for data and time information.

Data pertaining to containers can come from many sources and in a variety of formats. The data fusion center integrates and analyzes the data within the context of the supply chain to create information. The data fusion center also compares the information against known time standards and expected operational profiles to gain knowledge or intelligence about a container's security condition. The data fusion center 100 creates information from data by placing the data in context and organizing and indexing the data. The data fusion center 100, through its data analysis module 330 and report generation module 312 also generates reports that contain intelligence that explains the information. Through its communication tools 370, the data fusion center 100 offers the opportunity for real time notification, emergency notification, and crisis response. The data fusion center 100 consolidates the data and information into the context of the movement of each container and provides common links for agencies to access the data files.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A data fusion system for gathering and analyzing data from container tracking sources to produce intelligent output, wherein the container tracking sources include at least one container sensing system for monitoring contents of a container, the data fusion system comprising:
a data intake component for accepting container tracking data from multiple container tracking sources;
a data authentication component for authenticating the container tracking data and creating container information;
data analysis components for analyzing the information to create container intelligence; and
communication tools for providing real-time communications to convey container intelligence.

2. The system of claim 1, wherein the data intake component comprises a decryption mechanism for processing encrypted data.

3. The system of claim 1, wherein the data intake component comprises tools for accepting data in multiple formats.

4. The system of claim 1, further comprising a mapping component including user interface tools for illustrating container intelligence in geographical context.

5. The system of claim 4, wherein the mapping component includes a report generation component for generating and displaying a report through the user interface tools.

6. The system of claim 1, wherein the data analysis components comprise a Kalman filter.

7. The system of claim 1, wherein the communication tools comprise an alert notification module for generating an alarm to alert authorities.

8. The system of claim 1, further comprising an authentication server for authorizing agent access to the data fusion system, the authentication server connected with the data fusion system over a network.

9. A method for gathering and analyzing data from container tracking sources to produce intelligent output, wherein the container tracking sources include at least one container sensing system for monitoring contents of a container, the method comprising:
accepting container tracking data from multiple data tracking sources using a data intake component;
authenticating received container tracking data and creating container information using an authentication component;
analyzing the information to create container intelligence; and
providing real-time communications to convey container intelligence.

10. The method of claim 9, further comprising decrypting accepted encrypted data.

11. The method of claim 9, further comprising accepting data in each of encrypted data format, SMS messages, e-mail, Electronic Data Information (EDI), EDI-FAX, XML, and X.12

12. The method of claim 9, further comprising providing a mapping component including user interface tools for illustrating container intelligence in geographical context.

13. The method of claim 12, further comprising generating reports through the mapping component and displaying a report in geographic context through the user interface tools.

14. The method of claim 9, further comprising analyzing information by implementing a Kalman filter.

15. The method of claim 9, wherein providing real time communications comprises generating an alarm for authorities using an alert notification module.

16. The method of claim 9, further comprising controlling agent access to the container intelligence through an authentication server including voice recognition technology.

17. A computer readable medium comprising computer executable instructions for performing the method of claim 9.

18. A data fusion system for gathering and analyzing data from container tracking sources to produce intelligent output, wherein the container tracking sources include at least one container sensing system for monitoring contents of a container, the data fusion system comprising:
a data intake component for accepting container tracking data from multiple data tracking sources;
a data authentication component for authenticating the container tracking data and creating container information;
data analysis components for analyzing the information to create container intelligence; and
mapping components for generating intelligence reports and providing a user interface for facilitating viewing of the intelligence reports in geographical context.

19. The system of claim 18, wherein the data intake component comprises a decryption mechanism for processing encrypted data.

20. The system of claim 18, wherein the data intake component comprises tools for accepting data in multiple formats.

21. The system of claim 18, wherein the mapping components include a report generation component for generating and displaying a report through the user interface.

22. The system of claim 18, wherein the data analysis components comprise a Kalman filter.

23. The system of claim 18, further comprising communication tools including an alert notification module for generating an alarm to alert authorities.

24. The system of claim 18, further comprising an authentication server for authorizing agent access to the data fusion system, the authentication server connected with the data fusion system over a network.
